(19) United States
(12) Patent Application Publication
(10) Pub. No.: US 2008/0026811 A1
(43) Pub. Date: Jan. 31, 2008

(54) SYSTEM AND METHOD FOR BUYING AND PLAYING ELECTRONIC INSTANT SCRATCH OFF GAMES

(75) Inventors: David White, Boca Raton, FL (US); Abhishek Kumbhat, Johpur (IN)

Correspondence Address: GREENBERG TRAURIG, LLP, 1750 TYSONS BOULEVARD, 12TH FLOOR, MCLEAN, VA, 22102, US

(73) Assignee: LottoSoft Corporation, Boca Raton, FL (US)

(21) Appl. No.: 11/781,753

(22) Filed: Jul. 23, 2007

Related U.S. Application Data
(60) Provisional application No. 60/832,157, filed on Jul. 21, 2006.

(51) Int. Cl. A63F 13/00

(52) U.S. Cl. 463/17

(57) ABSTRACT

A plurality of electronic records, stored in a database, each representing an electronic instant scratch off game ticket, the records comprising an identifier and a prize. A lottery transaction processing module is also disclosed which facilitates the purchasing, via a communications network, of at least one of the electronic instant scratch off game tickets represented by the plurality of electronic records. A lottery client module is disclosed which provides an interface through which the player can purchase at least one of the electronic instant scratch off game tickets. Still further, a lottery management module is provided which retrieves the prize information associated with the electronic record from the database and provides the information to the lottery transaction processing module. The lottery management module can also authorize the lottery transaction module to deposit winnings into a lottery account associated with a winning player.

This application claims priority from Provisional U.S. Patent Application Ser. No. 60/832,157, filed on Jul. 21, 2006, which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates to the field of electronic instant scratch off game tickets used by state lotteries, and in particular to a system and method of providing electronic instant scratch off game tickets and related services on customer demand at customer premises.

### BACKGROUND

The passion to play on chance and dreams to instantly become a millionaire have made instant scratch off games popular. In the U.S. alone, billions of dollars are spent every year playing instant scratch off game tickets. Thousands of retail stores sell instant scratch off game tickets in each state, giving players access to a multitude of different games and an opportunity to win various amounts of money and prizes.

State lottery agencies typically impose complex procedures on instant scratch off game manufacturers to ensure that scratch off games function properly. For example, in most states the state lottery agency determines the odds of winning and the total number of cards to be brought to market. Following this, the lottery agency commissions the printing of instant scratch off tickets per the predetermined odds. Typically, the instant scratch off tickets include a unique identifier that the lottery agency can use to determine where a ticket was sold and what, if any, prize is associated with the ticket. Once the tickets are printed on card stock, and an appropriate cover layer is applied, they are randomly grouped into packets for distribution to retailers. Such randomness of the tickets assigned to each packet and in the distribution of the packets is necessary to maintain the integrity of the game.

The packets are assigned unique identifiers and the packets are distributed to the lottery retailers. The retailer, upon receipt of a packet, can activate the packets for sale using a lottery agency kiosk or the like. By employing identifiers at the ticket and packet level, the state lottery commission can readily track the location of each ticket and packet, at least up until the time of sale.

### SUMMARY

Although the above-described distribution method is advantageous because of the control it affords the state lottery agencies, it forces a player to visit a retailer's premises each time the player desires to play a lottery game. This is inconvenient and time consuming. In addition, because the real estate within the store is valuable, most retailers do not stock instant scratch off game tickets for each of the multitude of games that are available within their state. As a result, a player may need to search multiple retailer locations before finding a store that stocks his or her preferred game. Still further, since the availability of instant scratch off game tickets is subject to stock availability with a particular retailer, the player may have to search multiple retailers before tickets for a particular game can be purchased.

Accordingly, this disclosure is directed to a system and method for buying and playing electronic instant scratch off games that substantially obviates one or more of the problems due to limitations and disadvantages of the related art.

Some embodiments comprise a system comprising a plurality of electronic records, wherein each of the electronic records represents an electronic instant scratch off game ticket, wherein each electronic record has associated therewith an identifier and a prize, and wherein the plurality of electronic records are stored in a database; a lottery transaction processing module, wherein the lottery transaction processing module is communicatively coupled to a communication network, and wherein the lottery transaction processing module facilitates the purchasing of at least one of the electronic instant scratch off game tickets represented by the plurality of electronic records; a lottery account, wherein the lottery account associated with a player; a lottery client module, wherein the lottery client module is communicatively coupled to the communications network, wherein the lottery client module provides an interface through which the player can purchase from the lottery transaction processing module at least one of the electronic instant scratch off game tickets represented by the plurality of electronic records; and, a lottery management module, wherein the lottery management module retrieves the information about a prize associated with the electronic record from the database and provides the information to the lottery transaction processing module, and wherein the lottery management module authorizes the lottery transaction module to deposit winnings into the lottery account of a winning player. Such a lottery client module may further comprise a scratch off simulation module, wherein the scratch off simulation module simulates the user experience of scratching off a physical instant scratch off ticket. The scratch off simulation module can simulate the physical feel of scratching off a physical instant scratch off ticket via an input device. The lottery management module may further allow agents of a lottery agency to create new electronic records representing electronic instant scratch off game tickets. The database, the lottery management module, and the lottery transaction processing module may be under the control of a single entity, such as, without limitation, a lottery agency. The lottery client module can be implemented as firmware for a kiosk; as comprises software for use on a player device, such as, without limitation, a personal computer, a portable computing device, a cellular telephone, a personal digital assistant, or the like. The system may further comprise a master lottery account, wherein the lottery account is a virtual lottery account that denotes the player's share of a balance contained in the master lottery account. In some embodiments, the lottery client module may further comprise an authentication module, wherein the authentication module authenticates the player with the lottery transaction processing module prior to allowing the player to purchase at least one of the scratch off game tickets represented by the plurality of electronic records. Some embodiments may further comprise a tracking module, such as a module employing satellite navigation, LORAN-C, cellular telephone triangulation, or the like, wherein the tracking module provides a physical location for the player.

Some embodiments comprise a method for purchasing and playing electronic instant scratch off game tickets comprising providing a lottery account, wherein the lottery account is linked to a player; providing a database, wherein the database comprises a plurality of electronic records, wherein each of the electronic records represents an electronic instant scratch off game ticket, and wherein each electronic record has associated therewith an identifier and a prize; displaying at least one electronic instant scratch off game to the player via a lottery client module; receiving from the player at least one electronic instant scratch off game selection; receiving an identifier set from the lottery transaction processing module, wherein the identifier set comprises at least one identifier for each electronic instant scratch off game selection; receiving from the player a purchase confirmation via the lottery client module, wherein the purchase confirmation comprises at least one identifier; confirming that each identifier of the purchase confirmation is available by querying the database with the lottery transaction processing module; retrieving the prize associated with the electronic instant scratch off game selection from the database and providing the statistically linked prize to the lottery transaction processing module; and, authorizing the lottery transaction processing module to associate the prize with the lottery account. In some embodiments, the method further comprises authenticating the player with the lottery transaction processing module prior to allowing the player to purchase at least one of the electronic instant scratch off game tickets represented by the plurality of electronic records. In some embodiments, the method further comprises allowing agents of a lottery agency to create new electronic records representing electronic instant scratch off game tickets. In some embodiments, the method further comprises simulating the user experience of scratching off a physical electronic instant scratch off ticket via the lottery client module, such as by simulating the physical feel of scratching off a physical electronic instant scratch off ticket via an input device. In some embodiments, associating the prize with the lottery account comprises depositing winnings into the lottery account. In some embodiments, the lottery account is a virtual lottery account. In some embodiments, the method further comprises authorizing the player to purchase electronic instant scratch off game tickets by physical location, wherein the physical location is provided by a tracking module.

Additional features and advantages will be set forth in the description which follows, and in part will be apparent from this disclosure, or may be learned by practice of this disclosure. The objectives and other advantages will be realized and attained by the structure particularly pointed out in this written description, including any claims contained herein and the appended drawings.

Disclosed are a system and method which allow a player to buy and play electronic instant scratch off games from nearly any location and as many times as he or she wishes, which incorporate numerous security measures to maintain system integrity. Also disclosed are a shortened and simplified process chain for game distribution which can eliminate retailers from the distribution chain, making it attractive for both players and state lottery agencies.

It is to be understood that both the foregoing general description and the following detailed description are exemplary and explanatory and are intended to provide further explanation of the disclosed system and method for buying and playing electronic instant scratch off games using software.

### BRIEF DESCRIPTION OF THE DRAWINGS

The foregoing and other objects, features, and advantages will be apparent from the following more particular description and as illustrated in the accompanying drawings, in which reference characters refer to the same parts throughout the various views. The drawings are not necessarily to scale, emphasis instead being placed upon illustrating principles of the disclosed system and method.

FIG. 1 is a block diagram illustrating an exemplary architecture for an instant lottery system in accordance with various embodiments.

FIG. 2 is a flowchart illustrating an exemplary method of generating electronic instant scratch off game tickets in accordance with various embodiments.

FIG. 3 is a diagram illustrating an exemplary electronic instant scratch off game template in accordance with various embodiments.

FIG. 4 is a flowchart illustrating an exemplary method of purchasing and playing electronic instant scratch off game tickets in accordance with various embodiments.

FIG. 5 is an exemplary screen capture of a lottery client module wherein a player can authenticate using a username and password according to various embodiments.

FIG. 6 is an exemplary screen capture of a lottery client module displaying available electronic instant scratch off games according to various embodiments.

FIG. 7 is an exemplary screen capture of a lottery client module displaying additional instant scratch off game information according to various embodiments.

FIG. 8 is an exemplary screen capture of a lottery client module displaying a purchase confirmation according to various embodiments.

FIG. 9 is an exemplary screen capture of a lottery client module displaying an electronic instant scratch off game ticket prior to being scratched off according to various embodiments.

FIG. 10 is an exemplary screen capture of a lottery client module displaying an electronic instant scratch off game ticket being scratched off according to various embodiments.

FIG. 11 is an exemplary screen capture of a lottery client module displaying an electronic instant scratch off game ticket being scratched off according to various embodiments.

FIG. 12 is an exemplary screen capture of a lottery client module displaying an electronic instant scratch off game ticket after being scratched off according to various embodiments.

### DETAILED DESCRIPTION OF THE PREFERRED EMBODIMENT

Reference will now be made in detail to embodiments of the disclosed system and method, examples of which are illustrated in the accompanying drawings.

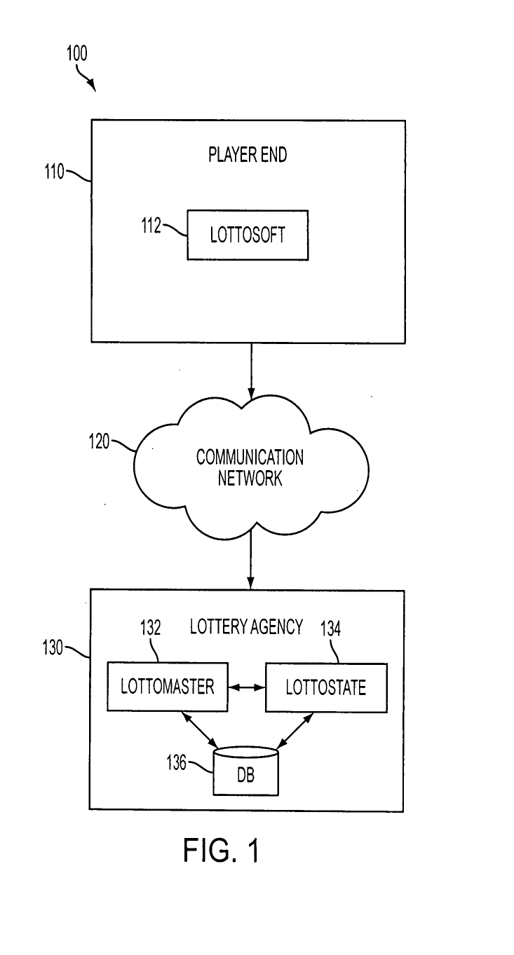

FIG. 1 illustrates a system architecture 100 for playing electronic instant scratch off games, in accordance with an embodiment. An electronic instant scratch off game can be played at a player end 110. Player end 110 can be located in nearly any location which has access to communication network 120, allowing a user many more opportunities to play electronic instant scratch off games than those offered by traditional electronic instant scratch off game distribution means. Player end 110 can include, but is not limited to a player's home, a player's workplace, or any place in which a player can gain access to communication network 120. A plurality of such player ends can be managed by a lottery agency 130.

Player end 110 and lottery agency 130 can be communicatively coupled to a communication network 120, such that player end 110 and lottery agency 130 can communicate. Communication network 120 may comprise a private or non-private network such as, but not limited to the Internet. In addition, some or all parts of the communications between player end 110 and lottery agency 130 may be secured using one or more secure communications methods including, without limitation, Virtual Private Networking (“VPN”), Secure Sockets Layer (“SSL”), the Advanced Encryption Standard (“AES”), Triple Data Encryption Standard (“3DES”), or the like.

In various embodiments, three software modules are used to allow players to buy and play electronic instant scratch off games from nearly any location. These software modules are “LottoSoft”, “LottoMaster”, and “LottoState”. Although emphasis is placed on a three module architecture, it should be apparent to one skilled in the art that the functions and features associated with the three disclosed codules can be combined, further delineated, or provided by an alternative architecture without departing from the spirit and scope of the disclosure.

The first module, “LottoSoft”, also referred to herein as lottery client module 112, is provided on player end 110. Lottery client module 112 can be provided as stand-alone software for use on a personal computer or other networked device capable of running software. Alternatively, lottery client module 112 can be provided as software interpretable or renderable by a world wide web browsing application (referred to herein as a “browser”). Lottery client module 112 can also be provided as firmware for a networked device specifically designed to be used with system architecture 100 for playing electronic instant scratch off games. In some embodiments, player end 110 may further comprise a printer to allow lottery client module 112 to print electronic instant scratch off game tickets, receipts, or other associated information.

The second module, “LottoMaster”, also referred to herein as a lottery transaction processing module 132, may be implemented at lottery agency 130 in some embodiments. In some embodiments, LottoMaster may be implemented by a third party service provider. In some embodiments, lottery transaction processing module 132 can be provided as software for use on commodity server hardware. Lottery transaction processing module 132 can be provided for use on a single server or as a distributed application for use across multiple servers. In some embodiments, lottery transaction processing module 132 can further comprise a financial institution module, wherein the financial institution module allows lottery transaction processing module 132 to transfer funds to and from financial institutions such as banks, credit card providers, and the like.

Lottery transaction processing module 132 acts as an intermediary between player end 110 and database 136 at lottery agency 130, allowing a user to purchase and play electronic instant scratch off games utilizing lottery client module 112. Database 136 can store a variety of information about a game, including, without limitation, records corresponding to each of the electronic instant scratch-off game tickets, prize information, revenues generated by the game, and the like. Database 136 may be implemented using any of a variety of well-known databases, including, without limitation, Microsoft Access or Microsoft SQL Server distributed by Microsoft Corporation of Redmond, Wash., Oracle Database distributed by Oracle Corporation of Redwood Shores, Calif., or MySQL available from MySQL Inc. of Cupertino, Calif.

Lottery transaction processing module 132 can further comprise an authentication module, wherein the authentication module provide a means for authenticating a user at player end 110 with lottery agency 130 through a username and password; two-factor authentication system such as SecurID® distributed by RSA Security Inc. of Bedford, Mass.; biometric identifier; or the like.

Lottery transaction processing module 132 may also provide software updates to lottery client module 112. By way of example, without limitation, where lottery client module 112 is implemented as firmware on a kiosk or similar device, lottery client module 112 may confirm that it is running the latest firmware by periodically checking for new firmware updates from lottery transaction processing module 132. In some embodiments, such confirmation may be performed each time lottery client module 112, or the device on which the module is running, is restarted. Similarly, lottery transaction processing module 132 may ensure that lottery client module 112 is running the latest firmware or other software version before the player can begin playing any of the electronic instant scratch off game or otherwise begin interacting with the system.

The third module, “LottoState”, also referred to herein as lottery management module 134, can be implemented at lottery agency 130. Lottery management module 134 can perform various administrative functions such as, but not limited to, querying database 136 to generate reports, generating new electronic instant scratch off games, and crosschecking winning claims from lottery transaction processing module 132. In embodiments wherein aspects of the instant system are implemented by third party providers, some or all of the aforementioned features and functions may also be implemented at the third party provider's location or otherwise made available to the third party provider.

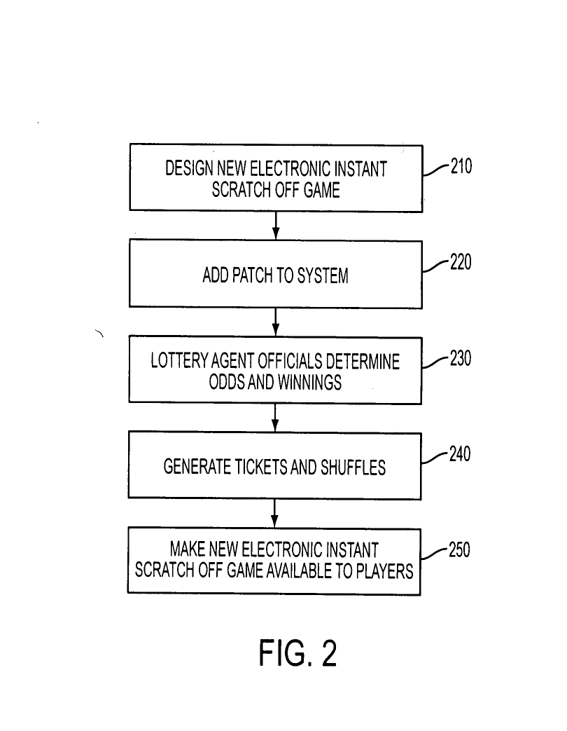

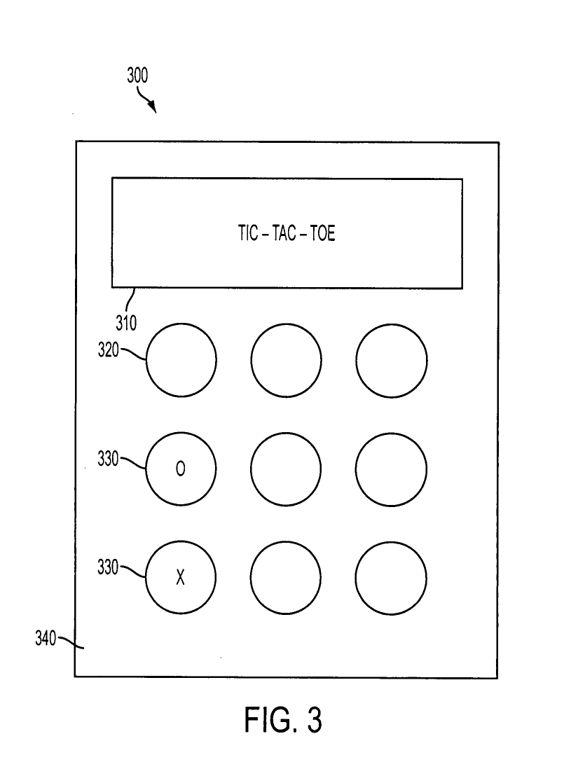

In some embodiments, such as the embodiment illustrated in FIG. 2, designing and deploying an electronic instant scratch off game can be seen as comprising five steps. In block 210, lottery personnel or others with appropriate permissions (referred to herein generally as lottery personnel) design a new electronic instant scratch off game template. Such an electronic instant scratch off game template can include a game title, visual design, one or more scratch off region(s), rules, and the like. One or more elements of the scratch off game template may be defined using a markup language, such as, but not limited to, eXtensible Markup Language (“XML”), Hypertext Markup Language (“HTML”), JavaScript, Asynchronous JavaScript and XML (“AJAX”), or the like. By way of example, without limitation, a new electronic instant scratch off game template could be a tic-tac-toe electronic instant scratch off game 300, as illustrated in FIG. 3. Game title 310 for tic-tac-toe electronic instant scratch off game 300 comprises the words “TIC-TAC-TOE.” Tic-tac-toe electronic instant scratch off game 300 contains nine scratch off regions, seven of which are non-played regions 320, and two of which are played regions 330. Tic-tac-toe electronic instant scratch off game 300 can also comprise a background 340, comprising drawings, pictures, and the like to make the game more visually appealing to a player.

The rules of an electronic instant scratch off game template determine how the player interacts with the electronic instant scratch off game and which combinations of scratch off region values define a winning ticket. By way of example, without limitation, tic-tac-toe electronic instant scratch off game 300 can comprise two scratch off region values, “X” or “O”. The rules for electronic instant scratch off game 300 could define a winning ticket as one in which three horizontally adjacent, three vertically adjacent, or three diagonally adjacent scratch off regions have the same value.

Referring again to FIG. 2, in block 220, lottery transaction processing module 132, lottery management module 134, and database 136 are updated to reflect the availability of a new electronic instant scratch off game template. In block 230, lottery agency official(s) define prize information and odds information for the new electronic instant scratch off game template using lottery management module 134. In some embodiments, lottery agency official(s) may periodically determine new prize information and odds information for a pre-existing electronic instant scratch off game template.

The prize information defines the type of prize that a player with a winning electronic instant scratch off game ticket will receive. Winning electronic instant scratch off game tickets may all have an identical prize associated with them, or there may be different prizes. Prizes may fall into a variety of categories including, but not limited to, free electronic instant scratch off game tickets, gift certificates to retailers, money, jewelry, vacations, or the like. In some embodiments, there may be prizes of differing value within a single category or across multiple categories. In some embodiments, a player with a winning electronic instant scratch off game ticket may be able to select a prize from a selection of prizes presented to the player.

The odds information determines the probability that any individual electronic instant scratch off game ticket is likely to be a winning ticket. In embodiments where winning electronic instant scratch off game tickets have an identical prize associated with them, the odds information can be a simple percentage, i.e., three percent of the electronic instant scratch off game tickets will be winners. In embodiments where multiple prizes are associated with the electronic instant scratch off game, the odds information may be more complex. By way of example, without limitation, an electronic instant scratch off game may have three prizes, a free electronic instant scratch off game ticket prize, a $5 prize, and a $10 prize. The odds information may be that five percent of players receive the free electronic instant scratch off game ticket prize, two percent of players receive the $5 prize, and one percent of players receive the $10 prize. As will be recognized by those of ordinary skill in the art, other methods of defining the odds information can be used without departing from the spirit or scope of the disclosure.

In block 240, lottery agency official(s) generate a plurality of electronic records, stored in database 136, wherein the plurality of electronic records represents a set of virtual or electronic instant scratch off game tickets. Each electronic record, which represents an individual electronic instant scratch off game ticket, comprises an associated identifier and a statistically associated prize. In some embodiments the identifier may comprise a fixed length or variable length series of digits or characters. The identifier may be sequentially or randomly assigned. In some embodiments the identifier may comprise a Universally Unique Identifier (“UUID”). The order in which the virtual electronic instant scratch off game tickets can be shuffled at a regular or random interval, to maintain randomness and integrity of the electronic instant scratch off game.

In block 250, the new electronic instant scratch off game is made available to players through lottery client module 112. In some embodiments, lottery transaction processing module 132 may provide an update to lottery client module 112 before lottery client module 112 can access the new electronic instant scratch off game. In some embodiments, lottery client module 112 may present an audible notification, a visual notification, or the like to players to alert them to the availability of the new electronic instant scratch off game.

In some embodiments, the invention requires every player to have a dedicated lottery account. Lottery accounts can be managed by lottery transaction processing module 132. Lottery accounts can be created using various means including, but not limited to, lottery client module 112, a kiosk, a website, in person at a lottery agency office, or the like. Players can add funds to their lottery account and transfer funds from their lottery account through a variety of means, including, without limitation, in person via a lottery kiosk or other, similar device; via electronic deposit, including a deposit from or to a credit card or debit card; via wire transfer; via a check mailed to or from the lottery agency; through a third party provider such as PayPal; or the like.

In some embodiments, the lottery account may be a single master account controlled by the lottery agency, to increase security. In these embodiments, player accounts are virtual accounts which denote the player's share of funds that are located in the master lottery account. By way of example, without limitation, the master lottery account may have a balance of $50,000, while a player's virtual account may have a balance of $100. In this example, the player's virtual account does not actually contain $100, it denotes that $100 of the $50,000 balance in the master lottery account belongs to the player.

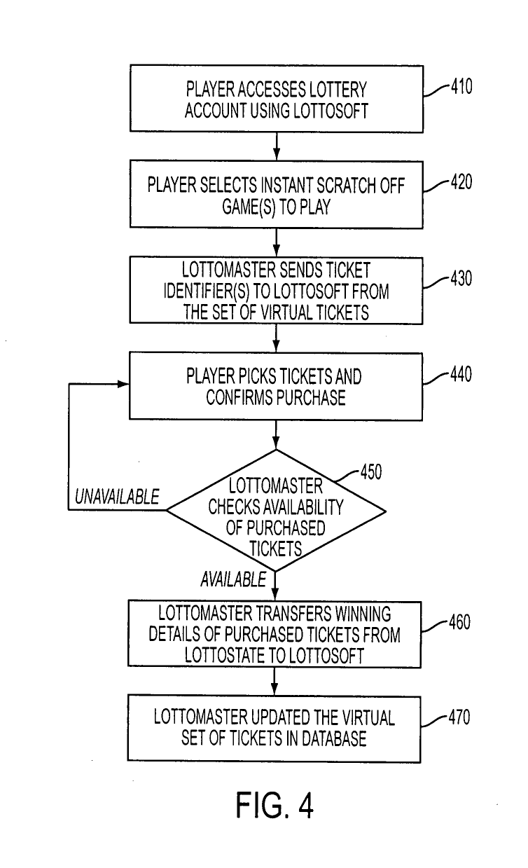

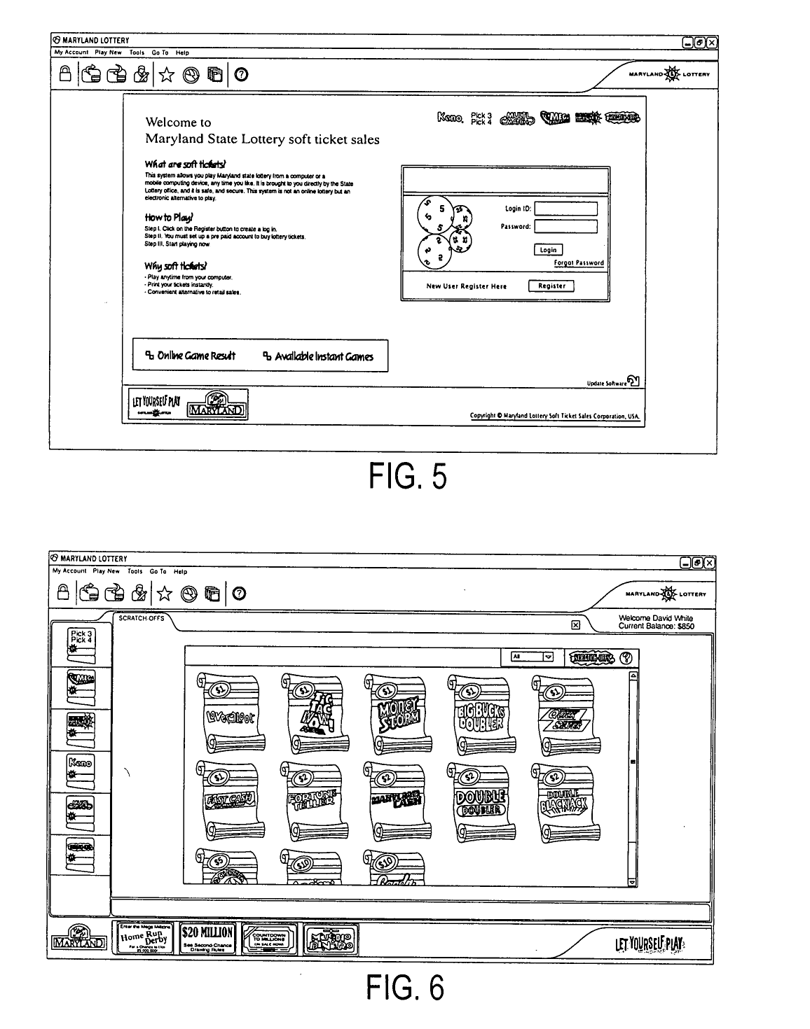

Referring to FIG. 4, in block 410 a player wishing to play an electronic instant scratch off game can access a lottery account through lottery client module 112. In some embodiments the player must be authenticated, by an authentication module, using one or more of a variety of authentication means, including, but not limited to, a usemame and password, two-factor authentication system such as SecurID® distributed by RSA Security Inc. of Bedford, Mass., biometric identifier, or the like, to gain access to the player's lottery account. FIG. 5 is an exemplary screen capture of lottery client module 112, wherein the authentication module allows the player to authenticate with a username and password. Once the player has successfully authenticated, lottery client module 112 can allow the player to, without limitation, manage the player's lottery account, play electronic instant scratch off games, redeem credits, track shipment/status of prizes, or the like.

In some embodiments, lottery client module 112 can further comprise a tracking module, wherein the tracking module can provide lottery client module 112 with the physical location of the player. In some embodiments, the tracking module may provide a highly accurate physical location, such as, but not limited to longitude and latitude in degrees, minutes, and seconds. In some embodiments, the tracking module may provide a general physical location, such as, but not limited to determining whether or not the player is within a physical boundary, such as within a certain state. The general physical location may be desired in instances where the player is concerned about privacy or providing the highly accurate physical location is not cost effective.

In some embodiments the physical location can be provided by a satellite navigation system, such as, but not limited to the U.S. Global Positioning System (“GPS”), the European Union Galileo system, or the like. In some embodiments, the physical location can be provided by triangulating the relative signal strength of a wireless signal, such as, but not limited to a cellular telephone signal, determining a relative location based upon which cellular telephone tower a player's cellular telephone is associated with, or the like. In some embodiments, the physical location can be provided by the player's internet protocol (“IP”) address.

In some embodiments the lottery agency may limit the player's ability to play electronic instant scratch off games based upon the physical location of the player provided by the tracking module. By way of example, without limitation, rules and regulations, such as, but not limited to the lottery agency charter, state gaming laws, federal gaming laws, or the like may only allow the lottery agency to provide instant scratch off game tickets within its host state. In this example, the authentication module can prevent the player from playing instant scratch off game tickets if the player is not physically located within the lottery agency's host state. In some embodiments, lottery client module 112 may require the player to re-authenticate after the player's physical location is within a region in which the player can play electronic instant scratch off game tickets. In some embodiments, the state lottery agency may restrict game play to only residents of the state. In such embodiments, the state lottery agency may mail an authorization code or other identifier to the player; cross-reference the player's information against motor vehicle, tax, or other records; or the like before permitting the player to access the system.

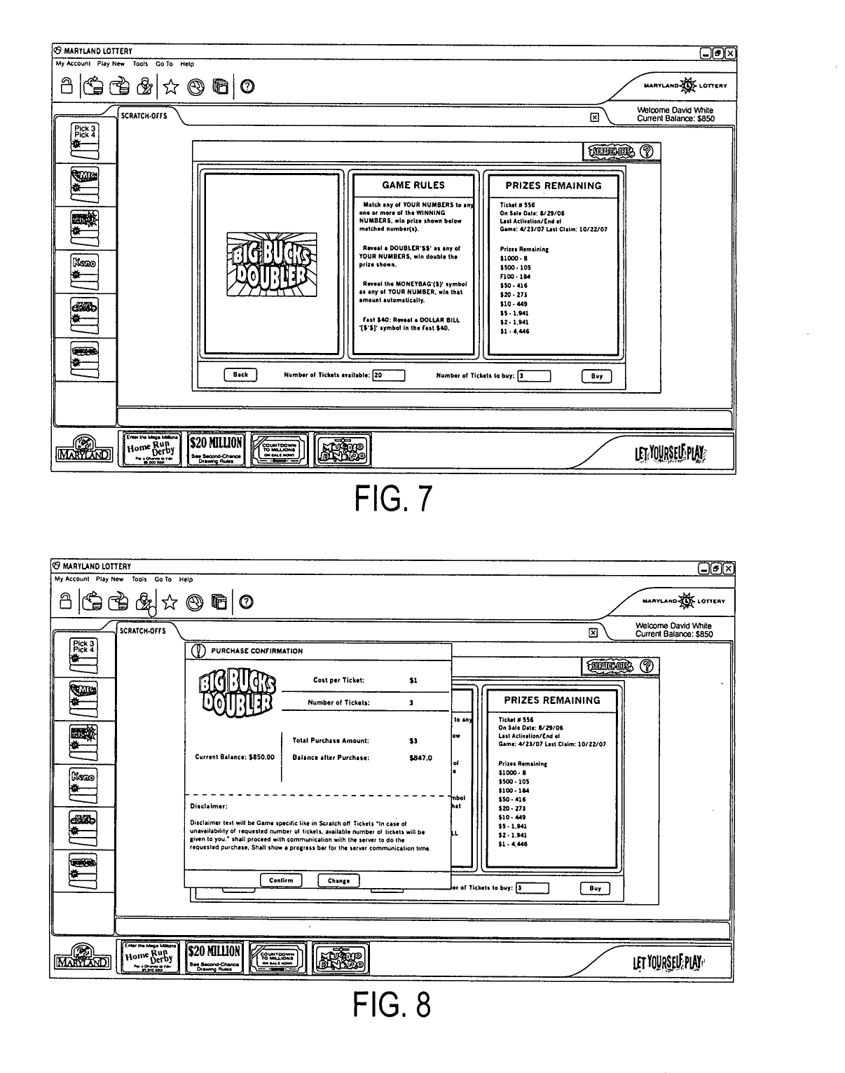

In block 420, lottery client module 112 allows the player to select one or more electronic instant scratch off games to play. Lottery client module 112 can present the available electronic instant scratch off games to the player in various formats including, but not limited to, the name of the electronic instant scratch off game, full size or “thumbnail” images of the game, game category, a random game selection, or the like. In some embodiments, as illustrated in FIG. 6, lottery client module 112 can present the available electronic instant scratch off games to the player by displaying the logo for each game. In some embodiments, lottery client module 112 allows the player to select more than one game at the same time. In some embodiments, lottery client module 112 may display additional instant scratch off game information to the player, such as, but not limited to, game rules, the number of remaining prizes, or the like, as illustrated in FIG. 7.

In some embodiments, all scratch off games are available to all players on LottoSoft until the last ticket is sold from the stock. This brings an enhanced player convenience and allows for more sales of tickets for the lottery agency. In alternative embodiments, the instant system may cease sales of a game once all winning tickets have been sold.

In block 430, in accordance with the player's selection, lottery transaction processing module 132 sends one or more sets of electronic instant scratch off game tickets to lottery client module 112. In some embodiments, the set of electronic instant scratch off game tickets contains the number of electronic instant scratch off game tickets selected by the player in block 420. In some embodiments, the set of electronic instant scratch off game tickets can contain more electronic instant scratch off game tickets than the player selected in block 420, such that the player can choose the specific electronic instant scratch off game tickets to be purchased. In some embodiments, for the purpose of increasing security, only the identifiers associated with the tickets are sent to lottery client module 112. The prize information associated with each ticket remains stored at the lottery agency, such that the information cannot be intercepted and used to influence the player's ticket selection, or by others observing game play in an effort to preempt any winnings.

In some embodiments, when a large number of players are simultaneously attempting to play the same electronic instant scratch off games, each player receives a different set of numbered tickets so that the probability of unavailability of a ticket upon purchase is minimized in block 430. In some embodiments, when the total number of concurrent players increases, lottery transaction processing module 132 can distribute the electronic instant scratch off game tickets in a way that minimizes the number of common electronic instant scratch off game tickets distributed to multiple lottery client modules 112. By way of example, without limitation, lottery transaction processing module 132 can keep a count of how many times each identifier has been transmitted to a player and assign those identifiers with the lowest count to subsequent requests.

In block 440, the player can use lottery client module 112 to select one or more electronic instant scratch off game tickets from the set of electronic instant scratch off game tickets sent from lottery transaction processing module 132. This can be seen as emulating the traditional distribution process for electronic instant scratch off game tickets, wherein packets are randomly distributed to retail stores. The player can confirm the purchase of the selected electronic instant scratch off game tickets, as illustrated in FIG. 8, causing lottery client module 112 to send the purchase confirmation to lottery transaction processing module 132.

In block 450, lottery transaction processing module 132 confirms that the electronic instant scratch off game tickets selected by the player are still available. In the case that one or more of the selected electronic instant scratch off game tickets are no longer available, lottery transaction processing module 132 will send a new set of electronic instant scratch off game tickets to lottery client module 112, as illustrated by block 440. In some embodiments, if alternate electronic instant scratch off game tickets are available in the same electronic instant scratch off game, lottery transaction processing module 132 will automatically select them for the player, without repeating block 440. If the selected instant scratch game tickets are available, lottery transaction processing module 132 will proceed to block 460.

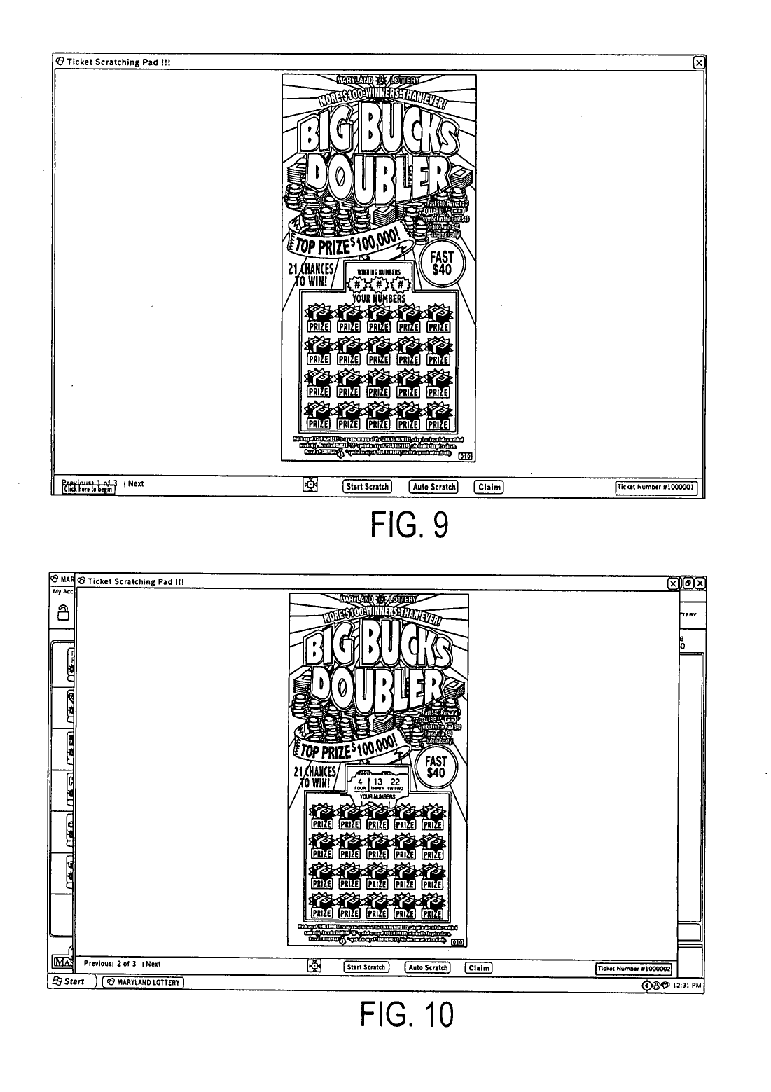

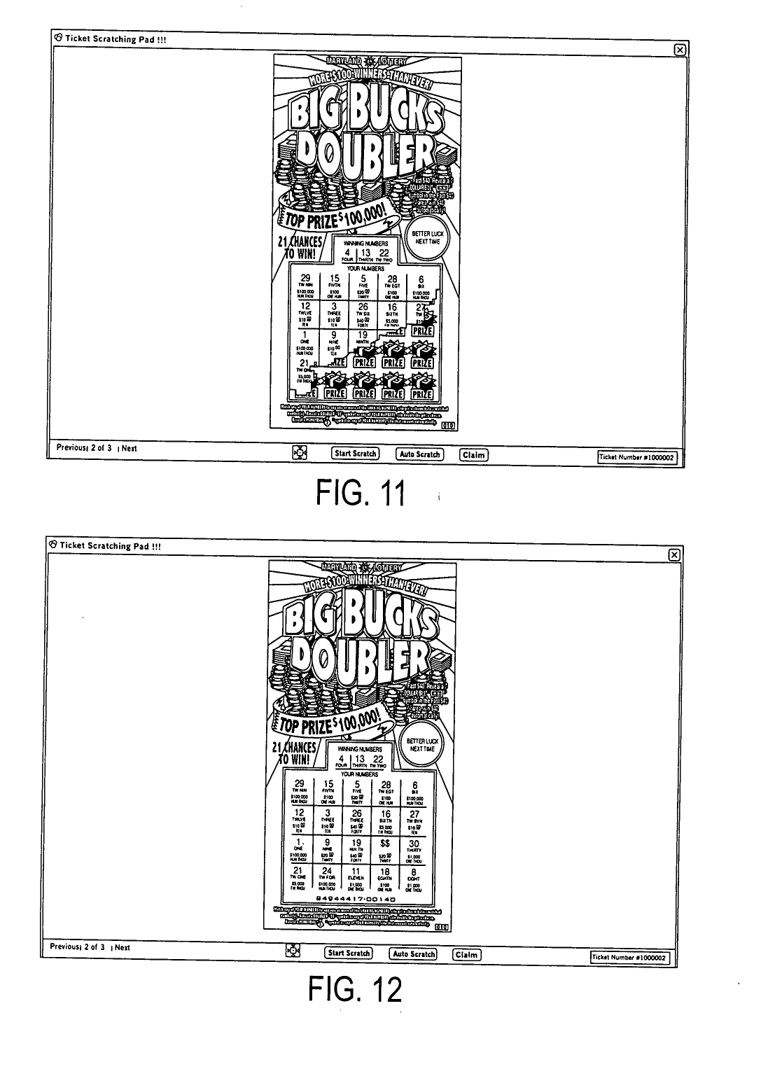

In block 460, lottery transaction processing module 132 retrieves the statistically associated prize for the identifier associated with each electronic instant scratch off game ticket purchased by the player from lottery management module 134. Lottery transaction processing module 132 sends the statistically associated prize information to lottery client module 112. In some embodiments, lottery client module 112 may further comprise a scratch off simulation module which simulates the user experience of physically scratching an instant scratch off game ticket by allowing the player to “scratch off” part of the electronic instant scratch off game ticket using a mouse; a joystick, cellular telephone, or other device capable of providing force or other tactile feedback; a touch screen; or the like, as illustrated by FIGS. 9-12. In FIG. 9, lottery client module 112 displays the instant scratch off game ticket to the player prior to scratching it off. In FIGS. 10-11, the scratch off simulation module allows the player to scratch off areas of the instant scratch off game ticket. In FIG. 12, lottery client module 112 displays the fully scratched off instant scratch off game ticket to the player, with the identifier. In some embodiments, lottery client module 112 can allow the player to select different scratch off regions, after which lottery client module 112 can animate a coin or other object scratching off the selected scratch off region. In some embodiments, lottery client module 112 may simply display the electronic instant scratch off game ticket with the scratch off region(s) already exposed. In all of the embodiments given, lottery client module 112 allows a player to experience the excitement and suspense of playing an electronic instant scratch off game from nearly any location.

In block 470, lottery transaction processing module 132 updates database 136 to remove the electronic instant scratch off game tickets purchased by the player. Lottery transaction processing module 132 crosschecks any winning electronic instant scratch off game tickets with lottery management module 134 before depositing winnings into the player's lottery account, bank account, or the like, or initiating alternative forms of payment.

The embodiments of the invention as described above provide a system and method of buying and playing electronic instant scratch off games from nearly any location. The traditional process chain associated with electronic instant scratch off lottery games has been shortened and simplified by eliminating thousands of retailers from the chain.

While the invention has been particularly shown and described with reference to a preferred embodiment thereof, it will be understood by those skilled in the art that various changes in form and details may be made therein without departing from the spirit and scope of the invention. For example, the teachings of U.S. Provisional Patent Application Ser. No. 60/710,159 filed Aug. 23, 2005 entitled “System And Method Of Playing Lottery Games, Buying And Printing Lottery Tickets From Home/Office Using Software On Computer” and U.S. Provisional Patent Application Ser. No. 60/726,705 filed Oct. 17, 2005 entitled “System And Method Of Playing Lottery Games, Buying And Printing Lottery Tickets Using Software On Mobile Computing Devices” may be utilized in practicing the present invention, and the teachings thereof are incorporated herein in their entirety.

We claim:

1. A system comprising:
a plurality of electronic records, wherein each of the electronic records represents an electronic instant scratch off game ticket, wherein each electronic record has associated therewith an identifier and a prize, and wherein the plurality of electronic records are stored in a database;
a lottery transaction processing module, wherein the lottery transaction processing module is communicatively coupled to a communication network, and wherein the lottery transaction processing module facilitates the purchasing of at least one of the electronic instant scratch off game tickets represented by the plurality of electronic records;
a lottery account, wherein the lottery account associated with a player;
a lottery client module, wherein the lottery client module is communicatively coupled to the communications network, wherein the lottery client module provides an interface through which the player can purchase from the lottery transaction processing module at least one of the electronic instant scratch off game tickets represented by the plurality of electronic records; and,
a lottery management module, wherein the lottery management module retrieves the information about a prize associated with the electronic record from the database and provides the information to the lottery transaction processing module, and wherein the lottery management module authorizes the lottery transaction module to deposit winnings into the lottery account of a winning player.

2. The system of claim 1, wherein the lottery client module further comprises a scratch off simulation module, wherein the scratch off simulation module simulates the user experience of scratching off a physical instant scratch off ticket.

3. The system of claim 2, wherein the scratch off simulation module simulates the physical feel of scratching off a physical instant scratch off ticket via an input device.

4. The system of claim 1, wherein the lottery management module further allows agents of a lottery agency to create new electronic records representing electronic instant scratch off game tickets.

5. The system of claim 1, wherein the database, the lottery management module, and the lottery transaction processing module are under the control of a single entity.

6. The system of claim 1, wherein the single entity is a lottery agency.

7. The system of claim 1, wherein the lottery client module is implemented as firmware for a kiosk.

8. The system of claim 1, wherein the lottery client module comprises software for use on a player device.

9. The system of claim 8, wherein the player device comprises a personal computer.

10. The system of claim 8, wherein the player device comprises a portable computing device.

11. The system of claim 8, wherein the portable computing device comprises a cellular telephone.

12. The system of claim 8, wherein the portable computing device comprises a personal digital assistant.

13. The system of claim 1, further comprising a master lottery account, wherein the lottery account is a virtual lottery account that denotes the player's share of a balance contained in the master lottery account.

14. The system of claim 1, wherein the lottery client module further comprises an authentication module, wherein the authentication module authenticates the player with the lottery transaction processing module prior to allowing the player to purchase at least one of the scratch off game tickets represented by the plurality of electronic records.

15. The system of claim 1, further comprising a tracking module, wherein the tracking module provides a physical location for the player.

16. The system of claim 15, wherein the tracking module comprises a satellite navigation system receiver.

17. A method for purchasing and playing electronic instant scratch off game tickets comprising:
providing a lottery account, wherein the lottery account is linked to a player;
providing a database, wherein the database comprises a plurality of electronic records, wherein each of the electronic records represents an electronic instant scratch off game ticket, and wherein each electronic record has associated therewith an identifier and a prize;
displaying at least one electronic instant scratch off game to the player via a lottery client module;
receiving from the player at least one electronic instant scratch off game selection;
receiving an identifier set from the lottery transaction processing module, wherein the identifier set comprises at least one identifier for each electronic instant scratch off game selection;
receiving from the player a purchase confirmation via the lottery client module, wherein the purchase confirmation comprises at least one identifier;
confirming that each identifier of the purchase confirmation is available by querying the database with the lottery transaction processing module;
retrieving the prize associated with the electronic instant scratch off game selection from the database and providing the statistically linked prize to the lottery transaction processing module; and,
authorizing the lottery transaction processing module to associate the prize with the lottery account.

18. The method of claim 17, further comprising authenticating the player with the lottery transaction processing module prior to allowing the player to purchase at least one of the electronic instant scratch off game tickets represented by the plurality of electronic records.

19. The method of claim 17, further comprising allowing agents of a lottery agency to create new electronic records representing electronic instant scratch off game tickets.

20. The method of claim 17, further comprising simulating the user experience of scratching off a physical electronic instant scratch off ticket via the lottery client module.

21. The method of claim 20, further comprising simulating the physical feel of scratching off a physical electronic instant scratch off ticket via an input device.

22. The method of claim 17, wherein associating the prize with the lottery account comprises depositing winnings into the lottery account.

23. The method of claim 17, wherein the lottery account is a virtual lottery account.

24. The method of claim 17, further comprising authorizing the player to purchase electronic instant scratch off game tickets by physical location, wherein the physical location is provided by a tracking module.
